(19) United States
(12) Patent Application Publication
(10) Pub. No.: US 2018/0189739 A1
(43) Pub. Date: Jul. 5, 2018

(54) FINDING A VIRTUAL TEAM WITHIN A COMPANY FOR A JOB POSTING

(71) Applicant: Linkedln Corporation, Sunnyvale, CA (US)

(72) Inventors: Krishnaram Kenthapadi, Sunnyvale, CA (US); Kaushik Rangadurai, Sunnyvale, CA (US)

(21) Appl. No.: 15/393,537

(22) Filed: Dec. 29, 2016

(51) Int. Cl. G06Q 10/10; G06Q 50/00; G06F 17/30

(52) U.S. Cl. CPC G06Q 10/1053; G06F 17/30864; G06Q 50/01

(57) ABSTRACT

Methods, systems, and programs are presented for finding a virtual team in a company based on the skills identified in a job posting, such that the virtual team has similar skills to the job posting skills. One method includes operations for generating member skill metrics for members of a social network, and for detecting a request for information about a company's job posting. Further, the method includes operations for determining job skill metrics associated with the job posting, and for calculating a similarity value between the job posting and employees of the company who are members of the social network, the similarity value being based on a comparison of the job skill metrics with the member skill metrics of each employee. The method further includes identifying a virtual team of employees having similarity values above a predetermined threshold and presenting the virtual team in a user interface.

### TECHNICAL FIELD

The subject matter disclosed herein generally relates to methods, systems, and programs for finding quality job offerings for a member of a social network.

### BACKGROUND

Some social networks provide job postings to their members. A member may perform a job search by entering a job search query, or the social network may suggest jobs that may be of interest to the member. However, current job search methods may miss valuable opportunities for a member because the job search engine limits the search to specific parameters. For example, the job search engine may look for matches of a job title in a job posting to the member's title, but there may be quality jobs that are associated with a different title that would be of interest to the member.

Further, existing job search methods may focus on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a group area in the user interface of FIG. 4, according to some example embodiments.

FIG. 6 is a diagram of a user interface, according to some example embodiments, for presenting a virtual team associated with a job posting.

FIG. 7 is a diagram of a user interface, according to some example embodiments, for presenting a virtual team within a company page.

FIG. 8 illustrates data structures for storing job and member information, according to some example embodiments.

FIG. 9 illustrates the training and use of a machine-learning program, according to some example embodiments.

FIG. 10 illustrates a method for identifying similarities among skills, according to some example embodiments.

FIG. 11 illustrates a method for finding a virtual team based on job data, according to some example embodiments.

FIG. 12 illustrates a method for presenting a virtual team, according to some example embodiments.

FIG. 13 illustrates a method for presenting a virtual team based on job skills and member skills, according to some example embodiments.

FIGS. 14A-14B illustrate the scoring of a job for a member, according to some example embodiments.

FIG. 15 illustrates a method for selecting jobs for presentation within a group, according to some example embodiments.

FIG. 16 illustrates a social networking server for implementing example embodiments.

FIG. 17 is a flowchart of a method, according to some example embodiments, for finding a virtual team in a company based on the skills identified in a job posting, such that the virtual team members have similar skills to the skills in the job posting.

FIG. 18 is a block diagram illustrating an example of a software architecture that may be installed on a machine, according to some example embodiments.

FIG. 19 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to finding a virtual team in a company based on the skills identified in a job posting, such that the virtual team members have similar skills to the skills in the job posting. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Most job seekers wonder how well they will fit in a new job. For example, a job seeker may wonder if she has the qualifications for the job and how she would compare to the people who have the job today, i.e., the people on the team that she would join if she took the job. This is why it is valuable for the job seeker to learn more about the backgrounds and qualifications of people who have the job today.

Some example embodiments present to the job seeker one or more of the employees in the company who currently are in a job role the same as or similar to that described in the job posting. These employees are referred to herein as the virtual team; snippets are presented to the job seeker with information about the virtual team members, such as names, qualifications, and backgrounds.

As used herein, a virtual team, defined for a job, is a group of people working at the same company who have professional skills similar to the professional skills defined in the job. Further, as used herein, a virtual team, defined for a member, is a group of people working at the same company who have professional skills similar to the professional skills of the member. Further yet, a virtual team may be defined for both a job and a member as a group of people working at the same company who have professional skills similar to the professional skills defined in the job and the professional skills of the member.

The people in the virtual team are referred to herein as the virtual team members, or simply the team members. The virtual team may include zero or more people, depending on how many people in the company match the skills of the job or the member. In some cases, the virtual team includes people who work on a product that is similar to the product that the member is working on.

Further, in some embodiments, the virtual team may be limited to a predetermined maximum number of virtual team members for presentation to the member. The virtual team may be presented, for example, to the member in the social network when the member is accessing company information or when the member is getting information for a job posted by the company.

One of the goals of the present embodiments is to personalize and redefine how job postings are searched and presented to job seekers. Another goal is to explain better why particular jobs are recommended to the job seekers. The presented embodiments provide both active and passive job seekers with valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is beneficial to the member for selecting jobs from the group, such as how many people have transitioned from the university of the member to the company of the job, who would be a virtual team for the member if the member joined the company, etc.

Embodiments presented herein define a virtual-team group that presents jobs to the member based on the respective strengths of the virtual teams in the different companies, where the strength of each virtual teams is calculated based on the professional curriculum (e.g., professional skills or accomplishments) of the virtual team members.

One general aspect includes a method including operations for generating, by one or more processors, member skill metrics for members of a social network, and for detecting a request for presentation of information about a job posting of a company. The method also includes determining one or more job skill metrics associated with the job posting, and calculating, by the one or more processors, a similarity value between the job posting and each of one or more employees of the company who are members of the social network. The similarity value is based on a comparison of the one or more job skill metrics with the member skill metrics of each employee of the company. The method further includes identifying, by the one or more processors, a virtual team of a plurality of employees having the similarity value above a predetermined threshold, and causing presentation of the virtual team in a user interface.

One general aspect includes a system including a memory including instructions and one or more computer processors. The instructions, when executed by the one or more computer processors, cause the one or more computer processors to perform operations including generating member skill metrics for members of a social network; detecting a request for presentation of information about a job posting of a company; determining one or more job skill metrics associated with the job posting; calculating a similarity value between the job posting and each of one or more employees of the company who are members of the social network, the similarity value being based on a comparison of the one or more job skill metrics with the member skill metrics of each employee of the company; identifying a virtual team of a plurality of employees having the similarity value above a predetermined threshold; and causing presentation of the virtual team in a user interface.

One general aspect includes a non-transitory machine-readable storage medium including instructions that, when executed by a machine, cause the machine to perform operations including generating, by one or more processors, member skill metrics for members of a social network; detecting a request for presentation of information about a job posting of a company; determining one or more job skill metrics associated with the job posting; calculating a similarity value between the job posting and each of one or more employees of the company who are members of the social network, the similarity value being based on a comparison of the one or more job skill metrics with the member skill metrics of each employee of the company; identifying a virtual team of a plurality of employees having the similarity value above a predetermined threshold; and causing presentation of the virtual team in a user interface.

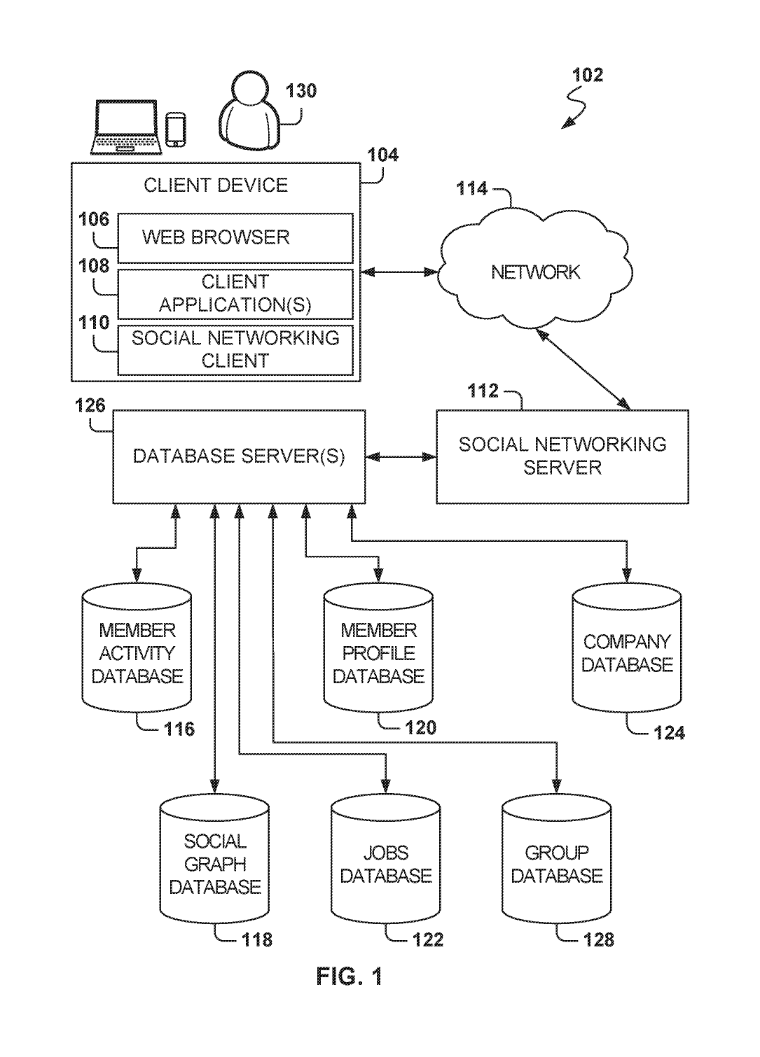

FIG. 1 is a block diagram illustrating a network architecture 102, according to some example embodiments, including a social networking server 112. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-128.

The client device 104 may comprise, but is not limited to, a mobile phone, a desktop computer, a laptop, a portable digital assistant (PDA), a smart phone, a tablet, a book reader, a netbook, a multi-processor system, a microprocessor-based or programmable consumer electronic system, or any other communication device that a user 130 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 130 may be a person, a machine, or another means of interacting with the client device 104. In various embodiments, the user 130 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi® network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 130, to identify or locate other connected members, etc.). Conversely, if the social networking client 110 is not included in the client device 104, the client device 104 may use the web browser 106 to access the social networking server 112.

Further, while the network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database servers 126 and database(s) 116-128. In one example embodiment, the social networking server 112 is communicatively coupled to a member activity database 116, a social graph database 118, a member profile database 120, a jobs database 122, a group database 128, and a company database 124. Each of the databases 116-128 may be implemented as one or more types of database including, but not limited to, a hierarchical database, a relational database, an object-oriented database, one or more flat files, or combinations thereof.

The member profile database 120 stores member profile information about members who have registered with the social networking server 112. With regard to the member profile database 120, a member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as his or her name, age (e.g., birth date), gender, interests, contact information, home town, address, spouse's and/or family members' names, educational background (e.g., schools, majors, matriculation and/or graduation dates, etc.), employment history, professional industry (also referred to herein simply as industry), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member of the social network, but some companies may not be members of the social network although some of the employees of the company may be members of the social network. The company database 124 includes company information, such as each company's name, industry, contact information, website, address, location, geographic scope, and the like.

As members interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content from outside of the social networking service (e.g., an article provided by an entity other than the social networking server 112), updating a current status, posting content for other members to view and comment on, suggesting jobs for the members, conducting job-post searches, and other such interactions. In one embodiment, records of these interactions are stored in the member activity database 116, which associates interactions made by a member with his or her member profile stored in the member profile database 120. In one example embodiment, the member activity database 116 includes the posts created by the members of the social networking service for presentation on member feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

The group database 128 includes group-related information. As used herein, a group includes jobs that are selected based on a group characteristic that provides an indication of why the jobs in the group are selected for presentation to the member. Examples of group characteristics include relationships between an educational institution of the member and the employees of a company who also attended the educational institution, virtual teams in the company with profiles similar to the member's profile, cultural fit of the member within the company, social connections of the members who work at the company, etc.

Members of the social networking service may establish connections with one or more other members of the social networking service. The connections may be defined as a social graph, where the member is represented by a vertex in the social graph and the edges identify connections between pairs of vertices. Members are said to be first-degree connections where a single edge connects the vertices representing the members; otherwise, members are said to have connections of the n^{th} degree, where n is defined as the number of edges separating the two vertices. In one embodiment, the social graph maintained by the social networking server 112 is stored in the social graph database 118.

In one embodiment, the social networking server 112 communicates with the various databases 116-128 through the one or more database servers 126. In this regard, the database server(s) 126 provide one or more interfaces and/or services for providing content to, modifying content in, removing content from, or otherwise interacting with the databases 116-128. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates directly with the databases 116-128 and includes a database client, engine, and/or module, for providing data to, modifying data stored within, and/or retrieving data from the one or more databases 116-128.

While the database server(s) 126 are illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-128, or combinations thereof. Accordingly, and in one embodiment, the database server(s) 126 implemented by the social networking service are further configured to communicate with the social networking server 112.

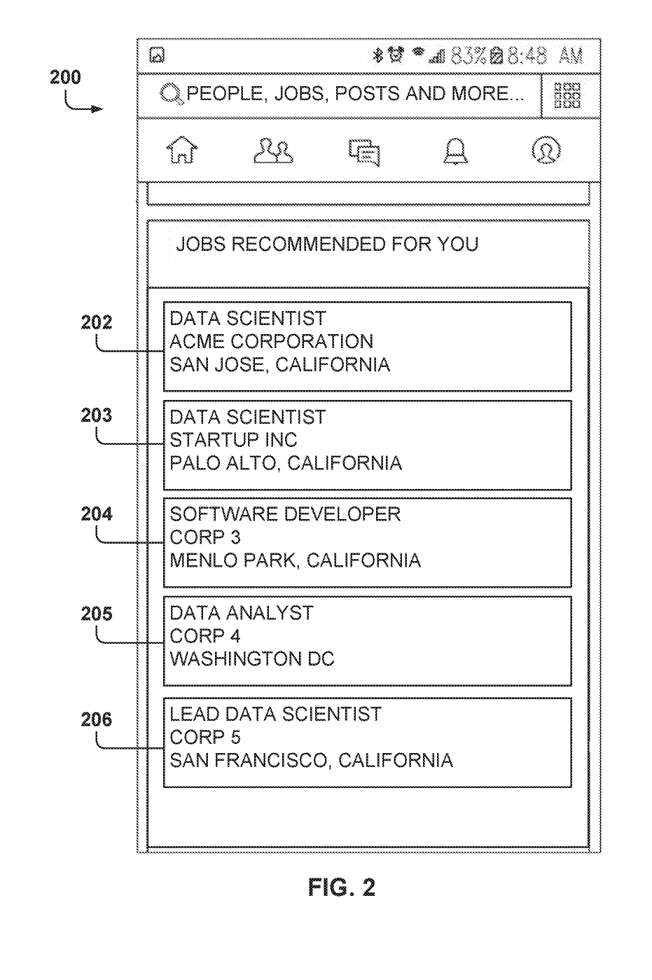

FIG. 2 is a screenshot of a user interface 200 that includes recommendations for jobs 202-206, according to some example embodiments. In one example embodiment, the social network user interface provides job recommendations, which are job postings that match the job interests of the user and that are presented without a specific job search request from the user (e.g., job suggestions).

In another example embodiment, a job search interface is provided for entering job searches, and the resulting job matches are presented to the user in the user interface 200. As the user scrolls down the user interface 200, more job recommendations are presented to the user. In some example embodiments, the job recommendations are prioritized to present jobs in an estimated order of interest to the user.

The user interface 200 presents a “flat” list of job recommendations as a single list. Other embodiments presented below utilize a “segmented” list of job recommendations where each segment is a group that is associated with a related reason indicating why these jobs are being recommended within the group.

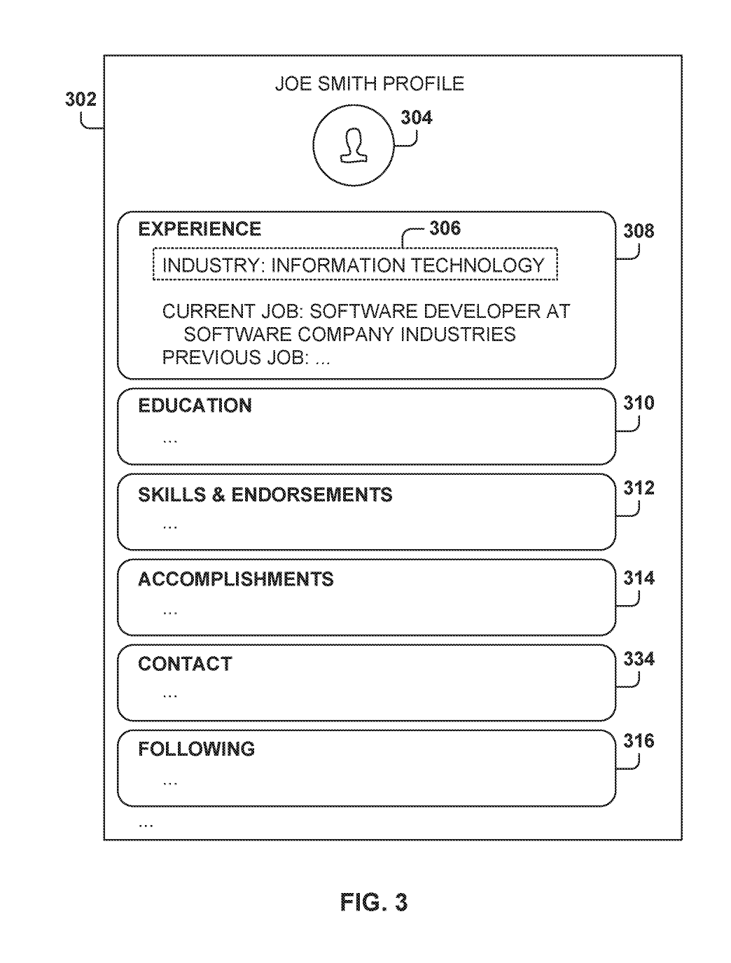

FIG. 3 is a screenshot of a user's profile view, according to some example embodiments. Each user in the social network has a member profile 302, which includes information about the user. The member profile 302 is configurable by the user and also includes information based on the user's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competencies that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account is associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, the user may list that the user attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, etc.

The skills and endorsements 312 information includes information about professional skills that the user has identified as having been acquired by the user, and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

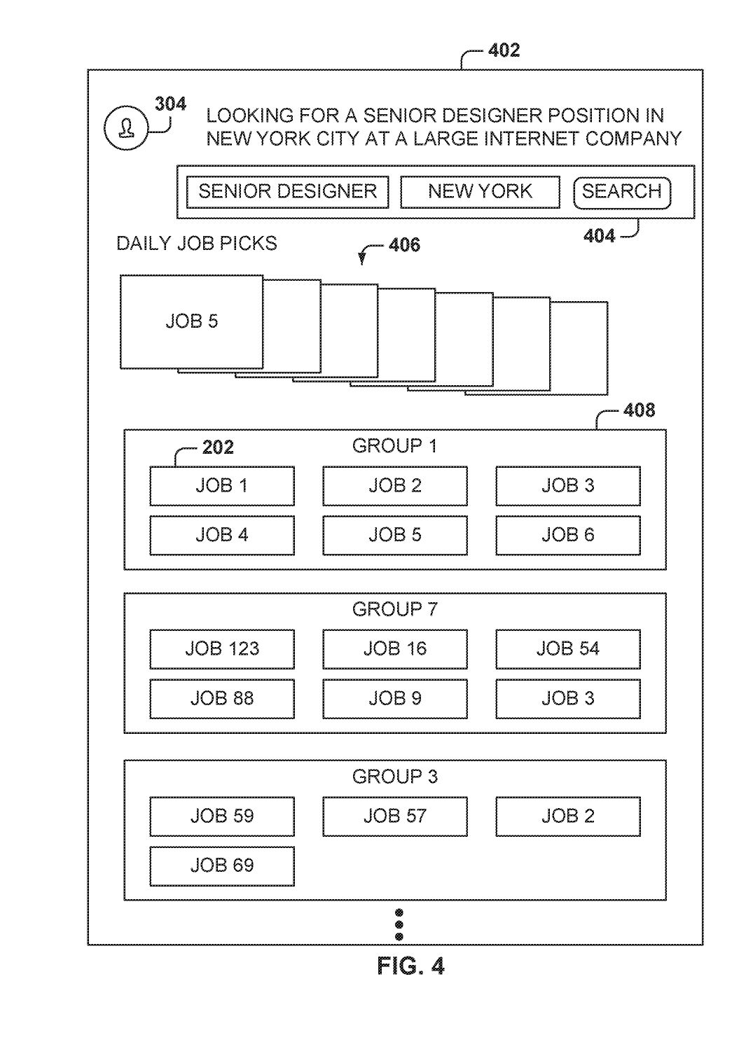

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search, e.g., “Looking for a senior designer position in New York City at a large Internet company.”

The search section 404, in some example embodiments, includes two boxes for entering search parameters: a keyword input box for entering any type of keyword for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and one search input may be entered at a time, or both search boxes maybe filled in.

The daily jobs section 406 includes information about one or more jobs selected for the user, based on one or more parameters, such as member profile data, search history, job match to the user, recentness of the job, whether the user is following the job, etc.

Each group area 408 includes one or more jobs 202 for presentation in the user interface 402. In one example embodiment, the group area 408 includes one to six jobs 202 with an option to scroll the group area 408 to present additional jobs, if available.

Each group area 408 provides an indication of why the member is being presented with those particular jobs 202, which identifies the characteristic of the group. There could be several types of reason related to the connection of the member to the job, the affinity of the member to the group, the desirability of the job, or the time deadline of the job (e.g., urgency). The reasons related to the connection of the member to the job may include relationships between the job and the social connections of the member (e.g., “Your connections can refer you to this set of jobs”), a quality of a fit between the job and the member characteristics (e.g., “This is a job from a company that hires from our school”), a quality of a match between the member's talent and the job (e.g., “You would be in the top 90% of all applicants”), etc.

Further, the group characteristics may be implicit (e.g., “These jobs are recommended based on your browsing history”) or explicit (e.g., “These are jobs from companies you followed”). The desirability reasons may include popularity of the job in the member's area (e.g., most-viewed by other members or most applications received), desired jobs from start-ups in the member's area, and popularity of the job among people with the same title as the member. Further yet, the time-urgency reasons may include “Be the first to apply to these jobs” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

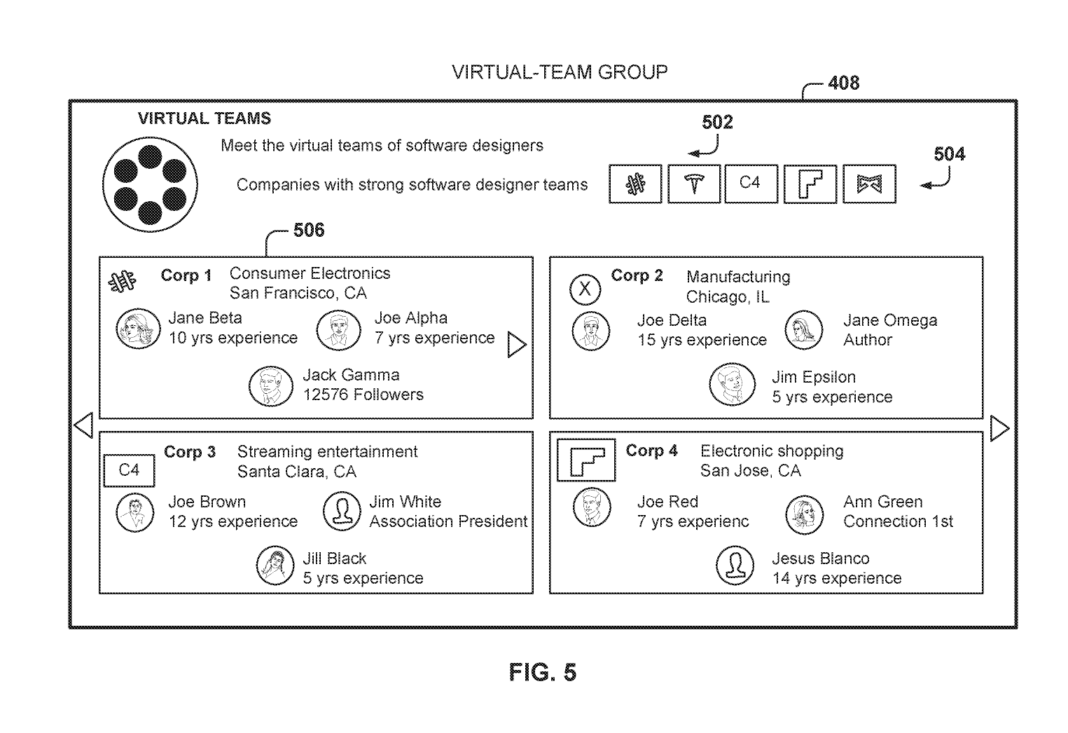

FIG. 5 is a detail of the group area 408 in the user interface 402, according to some example embodiments. In one example embodiment, the group area 408 is for a group referred to as a “virtual-teams group” and presents jobs in companies that have strong virtual teams. The goal is to find the virtual team for a specific job and the specific member. For example, if the member is a software designer, then a virtual team is created including people who are software designers working in the same company and in the same location as each other. There could be different teams in different locations, so the location may be used to separate the virtual teams, although in some other embodiments, the location is not considered for creating the virtual team.

Estimating the quality of the potential team for the member is beneficial because, in many cases, the job satisfaction of an employee is closely linked to the fit of the employee within the team and how the employee interacts with other team members at work.

In one example embodiment, the virtual-team group area 408 includes a group description area including the name of the group (e.g., “Virtual Teams”), and an introductory message 502 (e.g., “Meet the virtual teams of software designers”). In addition, some logos or profile pictures for the companies included in this group are presented in an icon area 504.

Each job 506 includes information about the job 506 and information about the virtual team. Information about the company posting the job 506 is presented, such as the logo of the company and the industry of the company, as well as the location for the job 506. The virtual team description includes a plurality of virtual team members, each with a respective profile picture, a name, and professional information (e.g., 10 years experience, 12576 followers). If a profile picture is not available for a user, a “ghost” picture may be displayed, where a ghost picture is a generic icon for a user without a profile picture.

In some example embodiments, the job description may also be included (not shown), such as the job title, job location, and job statistics (e.g., the number of days since the job was first posted, the number of members who have viewed the job, and the number of applications for the job received in the social network). In addition, any combination of profile pictures, member names, and member titles may be included to identify the connections of the member to the job via the member's connections in the social network.

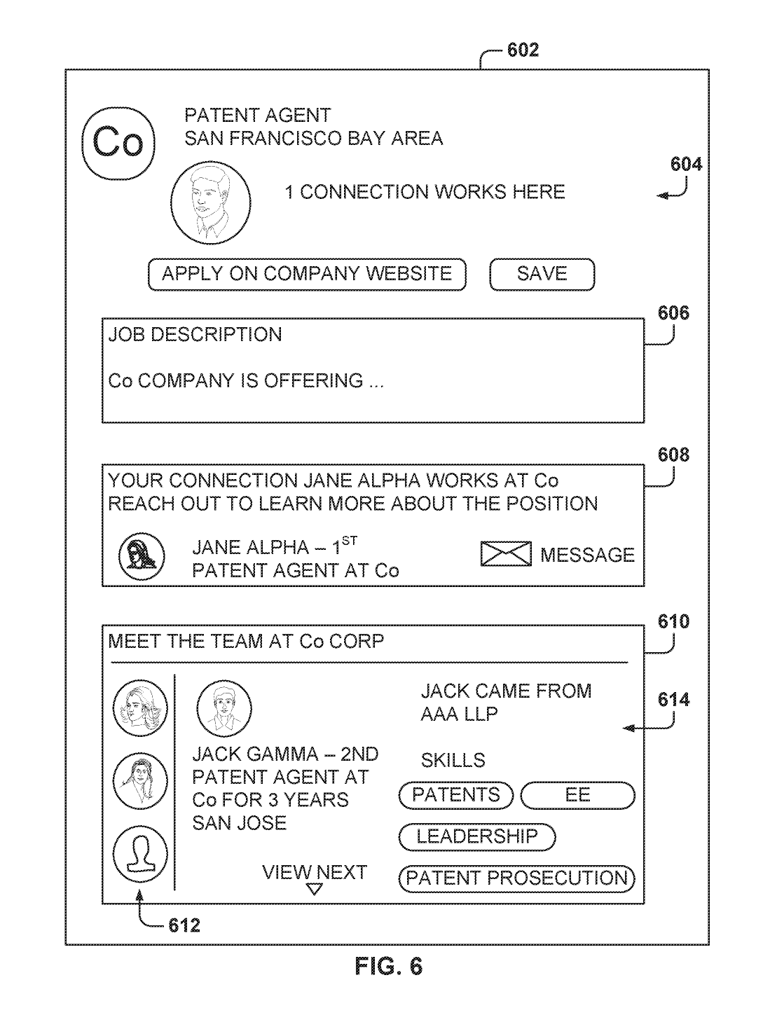

FIG. 6 is a diagram of a user interface 602, according to some example embodiments, for presenting a virtual team associated with a job posting. The user interface 602 is for presenting a job page to the member. The job page includes information about the job, such as the name of the company and connections who work at the company 604, buttons for applying to the job at the company website or for saving the job into the member's list of interesting jobs, a job description 606, a connections area 608, and a virtual team area 610. The connections area 608 presents one or more members of the social network who work at the company that posted the job and who are socially connected to the member in the social network (directly or indirectly).

The virtual team area 610 includes a header (e.g., “Meet the team at Co Corp”), and information about the members of the virtual team. For example, one of the virtual team members is highlighted, and information 614 of this member is presented in more detail, including the member's profile picture, name, professional experience, and skills. A scrolling option is available (e.g., “View next”) to select the next member of the virtual team.

On the left, profile pictures 612 for other team members are presented, and if the member clicks on one of the profile pictures 612, the detailed information for the selected team member is presented. Thus, the user interface 602 shows people who may work with the member if the member joined the company. One of the reasons for choosing a job is that a member may want to work in a good team. These are possibly the people whom the member will interact with on a day-to-day basis.

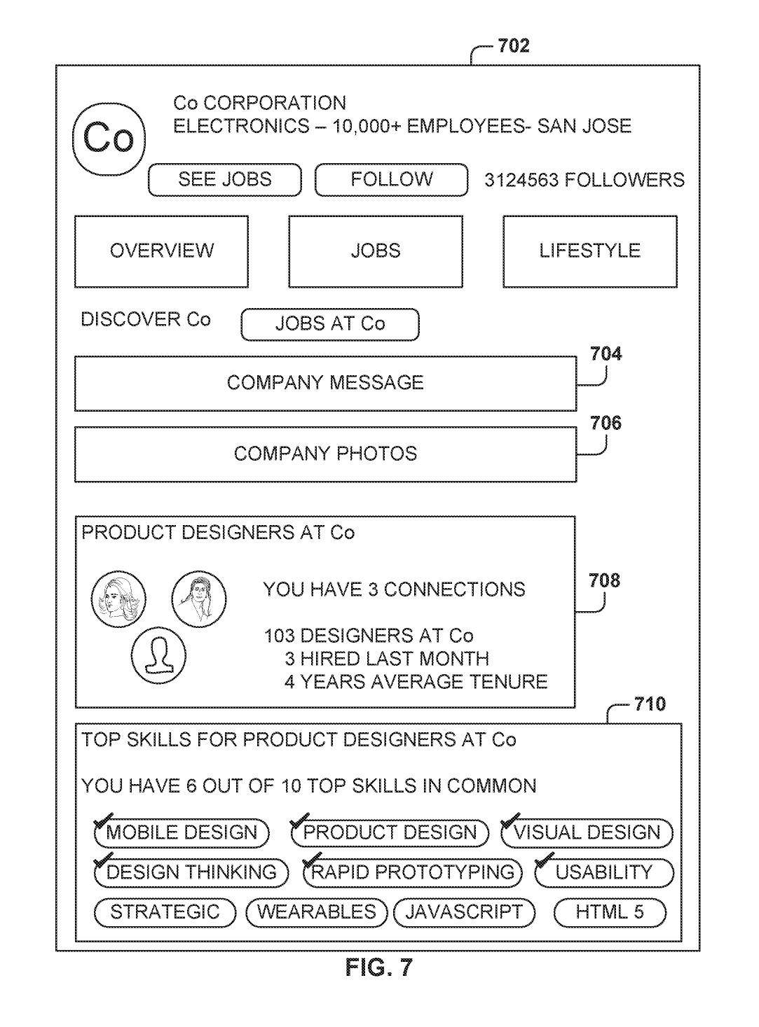

FIG. 7 is a diagram of a user interface, according to some example embodiments, for presenting a virtual team within a company page. The user interface shows a company page 702 with information about a company. The member may reach the company page 702 during a search for the company information or when inquiring about a job offered by the company.

The company page 702 includes company information, such as a company name, a company logo, a company overview, jobs at the company, a lifestyle associated with the company, a company message 704, company photos 706, a virtual team 708, and team skills 710. Some buttons are presented, such as a button to find jobs in the company or to follow the company in the social network.

The virtual team 708 includes information about the virtual team, such as profile pictures, names, professional information, a number of connections of the member to employees in the virtual team 708, and statistics about employees in the virtual team with the same title as the member (e.g., “103 designers at Co, three hired last month”).

The team skills 710 provides information about the skills of the virtual team members and how they relate to the skills of the member. For example, the team skills 710 identifies the top skills for product designers at the company, and indicates that the member has six out of ten of the top skills in common with the virtual team. In some example embodiments, the top skills are listed, and a checkmark is placed on each of the skills that the member shares with the virtual team members, but other interfaces for presenting the skills are also possible.

It is to be noted that the embodiments illustrated in FIGS. 6 and 7 are examples and do not describe every possible embodiment. Other embodiments may utilize different layouts, additional or less information, etc. The embodiments illustrated in FIGS. 6 and 7 should therefore not be interpreted to be exclusive or limiting, but rather illustrative.

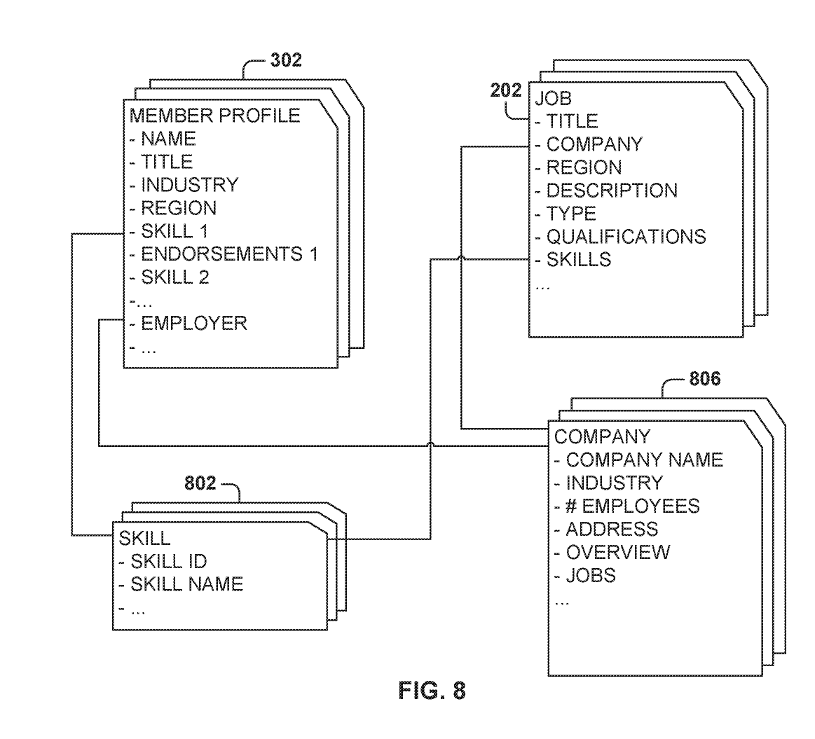

FIG. 8 illustrates data structures for storing job and member information, according to some example embodiments. The member profile 302, as discussed above, includes member information, such as the member's name, title (e.g., job title), industry (e.g., legal services), geographic region, employer, skills and endorsements, and so forth. In some example embodiments, the member profile 302 also includes job-related data, such as jobs the member has previously applied to, or jobs already suggested to the member (and how many times each job has been suggested to the member). Within the member profile 302, the skill information is linked to skill data 802, and the employer information is linked to company data 806.

In one example embodiment, the company data 806 includes company information, such as a company name, an industry associated with the company, a number of employees at the company, an address of the company, an overview description of the company, job postings associated with the company, and the like.

The skill data 802 is a table for storing information about the different skills identified in the social network. In one example embodiment, the skill data 802 includes a skill identifier (ID) (e.g., a numerical value or a text string) and a name for the skill The skill identifier may be linked to the member profile 302 and job 202 data.

In one example embodiment, the job 202 data includes data for jobs posted by companies in the social network. The job 202 data includes one or more of a title associated with the job (e.g., Software Developer), a company that posted the job, a geographic region where the job is located, a description of the job, a type of the job, qualifications required for the job, and one or more skills. The job 202 data may be linked to the company data 806 and the skill data 802.

It is to be noted that the embodiments illustrated in FIG. 8 are examples and do not describe every possible embodiment. Other embodiments may utilize different data structures or fewer data structures, combine the information from two data structures into one, have additional or fewer links among the data structures, and the like. The embodiments illustrated in FIG. 8 should therefore not be interpreted to be exclusive or limiting, but rather illustrative.

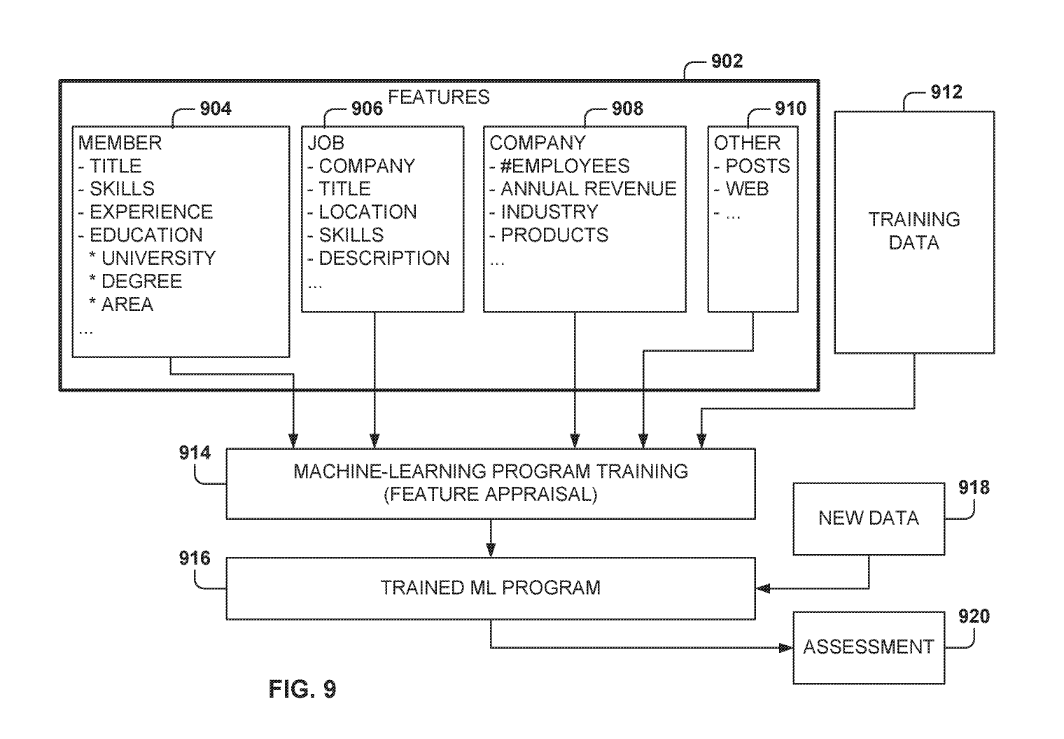

FIG. 9 illustrates the training and use of a machine-learning program according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 912 in order to make data-driven predictions or decisions expressed as outputs or assessments 920. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

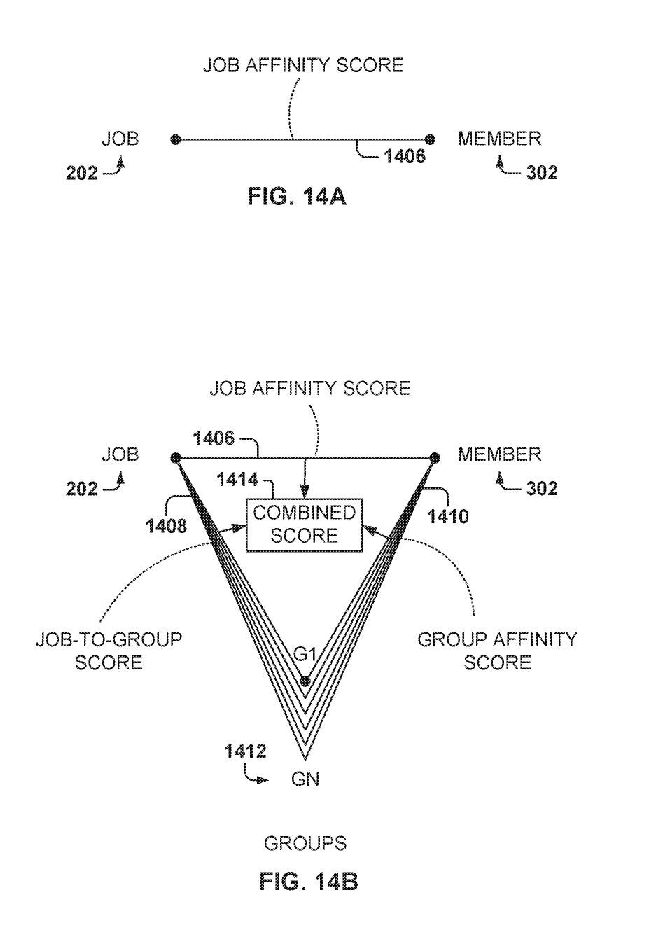

In general, there are two types of problem in machine learning: classification problems and regression problems. Classification problems aim at classifying items into one of several categories (for example, is this object an apple or an orange?). Regression problems aim at quantifying some items (for example, by providing a value that is a real number). In some embodiments, example machine-learning algorithms provide a job affinity score (described in more detail below with reference to FIG. 14A) (e.g., a number from 1 to 100) to qualify each job as a match for the user (e.g., calculating the job affinity score). In other example embodiments, machine learning is also utilized to calculate a group affinity score and a job-to-group score, as discussed in more detail below with reference to FIG. 14B. The machine-learning algorithms utilize the training data 912 to find correlations among identified features 902 that affect the outcome. In yet other embodiments, machine-learning algorithms are utilized for determining similarities between skills of members, or between the professional attributes of members (which include skills, title, industry, and other professional information).

In one example embodiment, the features 902 may be of different types and may include one or more of member features 904, job features 906, company features 908, and other features 910. The member features 904 may include one or more of the data in the member profile 302, as described in FIG. 8, such as title, skills, experience, education, etc. The job features 906 may include any data related to the job, and the company features 908 may include any data related to the company. In some example embodiments, additional features in the other features 910 may be included, such as post data, message data, web data, etc.

With the training data 912 and the identified features 902, the machine-learning tool is trained at operation 914. The machine-learning tool appraises the value of the features 902 as they correlate to the training data 912. The result of the training is a trained machine-learning program 916.

When the trained machine-learning program 916 is used to perform an assessment, new data 918 is provided as an input to the trained machine-learning program 916, and the trained machine-learning program 916 generates the assessment 920 as output. For example, when a member performs a job search, a machine-learning program, trained with social network data, uses the member data and job data from the jobs in the database to search for jobs that match the member's profile and activity.

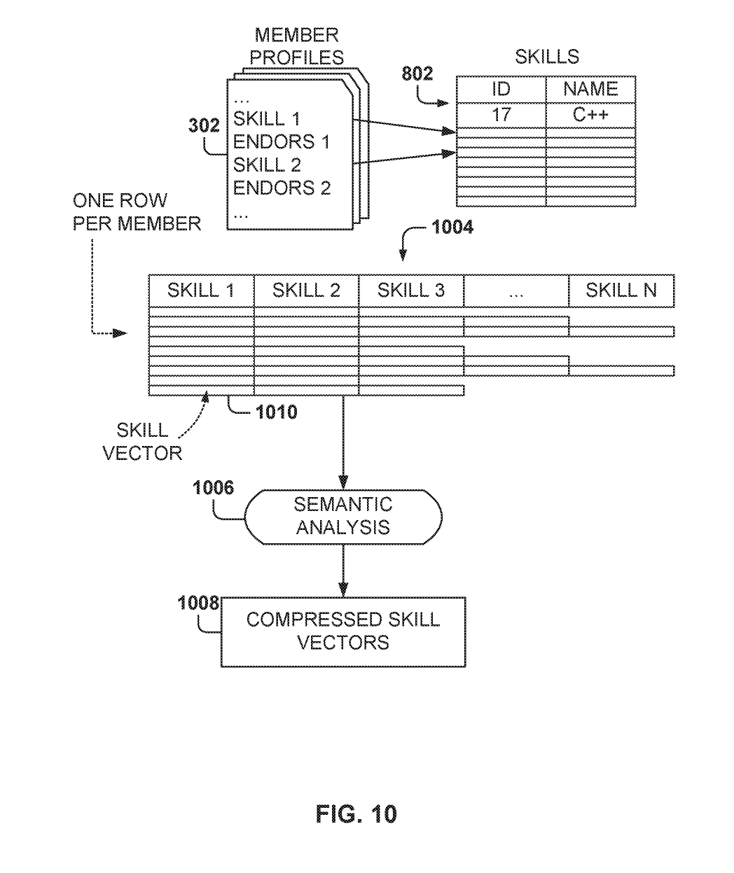

FIG. 10 illustrates a method for identifying similarities among skills, according to some example embodiments. In some example embodiments, the skills of the members of the social network are represented within a vector in a small-dimensional space (e.g., with a dimension of 200).

In some example embodiments, a job posting includes an explicit definition of skills desired for the applicant. In other example embodiments, job data (e.g., title and description) is analyzed to extract skills associated with the job posting, and these extracted skills may be added to the skills explicitly defined for the job.

Some example embodiments are presented for comparing member skills, but the same principles may be applied to comparing other features in addition to the skills, such as title, position, function within the company, years of experience, etc., or any combination thereof. In some example embodiments, semantic vectors are created for the skills of members, and in other embodiments, the semantic vectors include the skills, the titles, and the job functions, for example.

Reducing vector dimension from a sparse vector representation to a compressed vector representation may be done in several ways. In one embodiment, the skills and title of each member are placed within a row, and then matrix factorization is utilized to reduce the vectors to a smaller dimension, such as 50 or 100. Then, in the reduced-dimension space, a nearest-neighbor computation from the job skills is performed, restricted to the employees of the company of interest, resulting in a similarity coefficient for each employee. This way, the members with similar skills in the job are found. Afterwards, the top members with the best similarity coefficients are selected for the virtual team. For example, the virtual team may include the top four members, the top six members, the top 50 members, etc.

In some example embodiments, a similarity threshold is defined, and people are selected for the virtual team when their similarity coefficient with reference to the job skills is above the similarity threshold. Therefore, there could be cases where there is no virtual team for the job in the company posting the job.

As used herein, the similarity coefficient between a first skill vector and a second skill vector is a real number that quantifies a similarity between the respective skills. The similarity coefficient is also referred to herein as the similarity value. In some example embodiments, the similarity coefficient is in the range 0 to 1, but other ranges are also possible. In some embodiments, cosine similarity is utilized to calculate the similarity coefficient between the skill vectors.

In some example embodiments, the skill data 802 includes a skill identifier (e.g., an integer value) and a skill description text (e.g., C++). The member profiles 302 are linked to the skill identifier, in some example embodiments.

Semantic analysis finds similarities among member skills by creating a skill vector 1008 for each member such that members with similar skills have skill vectors 1008 near each other. In one example embodiment, the tool Word2vec is used to perform the semantic analysis, but other tools may also be used, such as Gensim, Latent Dirichlet Allocation (LDA), or Tensor flow.

These models are shallow, two-layer neural networks that are trained to reconstruct linguistic contexts of words. Word2vec takes as input a large corpus of text and produces a high-dimensional space. Each unique word in the corpus is assigned a corresponding vector in the space. The vectors are positioned in the space such that words that share common contexts in the corpus are located in close proximity to one another in the space. In one example embodiment, each element of the skill vector 1008 is a real number.

Initially, a simple skill vector 1010 is created for each skill, where each simple skill vector 1010 includes a plurality of zeros and a one at the location corresponding to the skill. Afterwards, a concatenated skill table 1004 is created, where each row includes a sequence indicating all the skills for a corresponding member. Thus, the first row of the concatenated skill table 1004 includes all the simple skill vectors 1010 for the skills of the first member, the second row includes all the simple skill vectors 1010 for the skills of the second member, and so forth.

A semantic analysis operation 1006 is then performed on the concatenated skill table 1004. In one example embodiment, Word2vec is utilized, and the result is compressed skill vectors 1008, or simply “skill vectors,” such that members with similar skills have skill vectors 1008 near each other (e.g., with a similarity coefficient below a predetermined threshold).

Some example results for “machine learning” (with the skill identifier in parenthesis) include the following:

pattern recognition (5449), 0.9100;

neural network (4892), 0.9053;

artificial intelligence (2407), 0.8989;

natural language processing (5835), 0.8836;

algorithm (1070), 0.8834;

algorithm design (6001), 0.8791;

computer vision (4262), 0.8779;

latex (6420), 0.8500;

computer science (1541), 0.8441;

deep learning (50518), 0.8411;

data mining (2682), 0.8356;

texting mining (7198), 0.8326;

parallel computing (5626), 0.8308;

recommender system (12226), 0.8306;

artificial neural network (12469), 0.8252;

data science (50061), 0.8213;

genetic algorithm (7630), 0.8093;

python (1346), 0.8037; and

image processing (2741), 0.8019.

Once the compressed skill vectors 1008 are identified, the skills of the job are identified, and a vector for the job is created by combining the vectors of the different skills associated with the job. Once the job skill vector is available, the job skill vector may be used to find the members of the virtual team who have compressed skill vectors 1008 similar to the job skill vector.

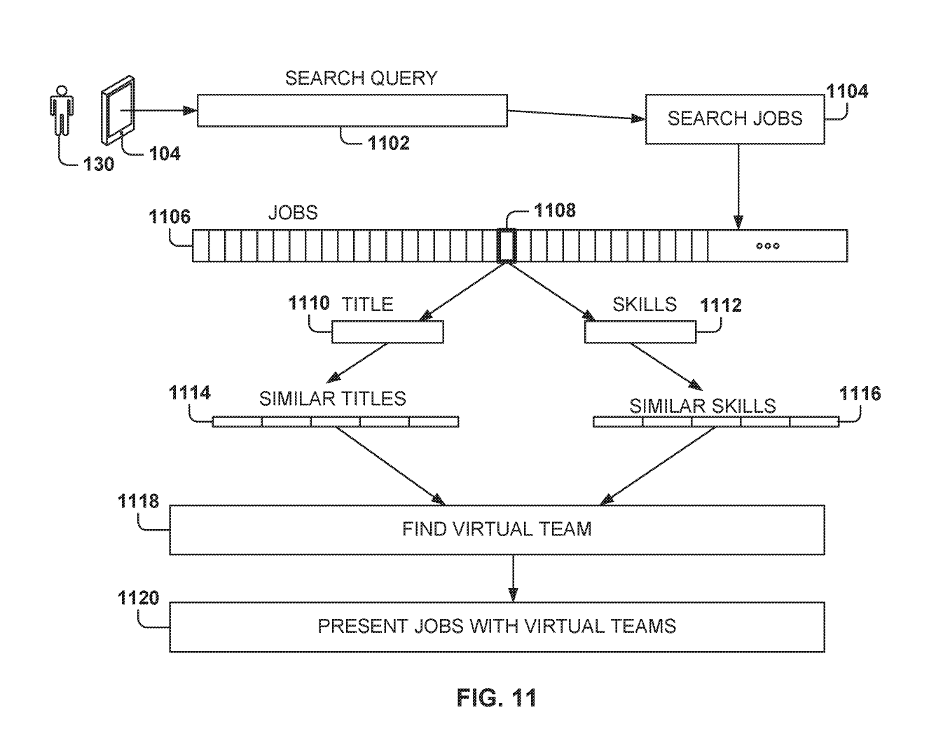

FIG. 11 illustrates a method for finding a virtual team based on job data, according to some example embodiments. A search query 1102 is performed for the user 130 using the client device 104 in operation 1104 to obtain a plurality of jobs 1106. For a job 1108, a title 1110 and skills 1112 are identified for finding the virtual team in the company posting the job 1108.

In some example embodiments, the title 1110 may be expanded with similar titles 1114 for finding the virtual team and the skills 1112 may be expanded with similar skills 1116 for finding the virtual team. It is to be noted that utilizing the similar titles 1114 and utilizing the similar skills 1116 are optional operations, and the virtual team may be found with only the title 1110 and the skills 1112, in other embodiments.

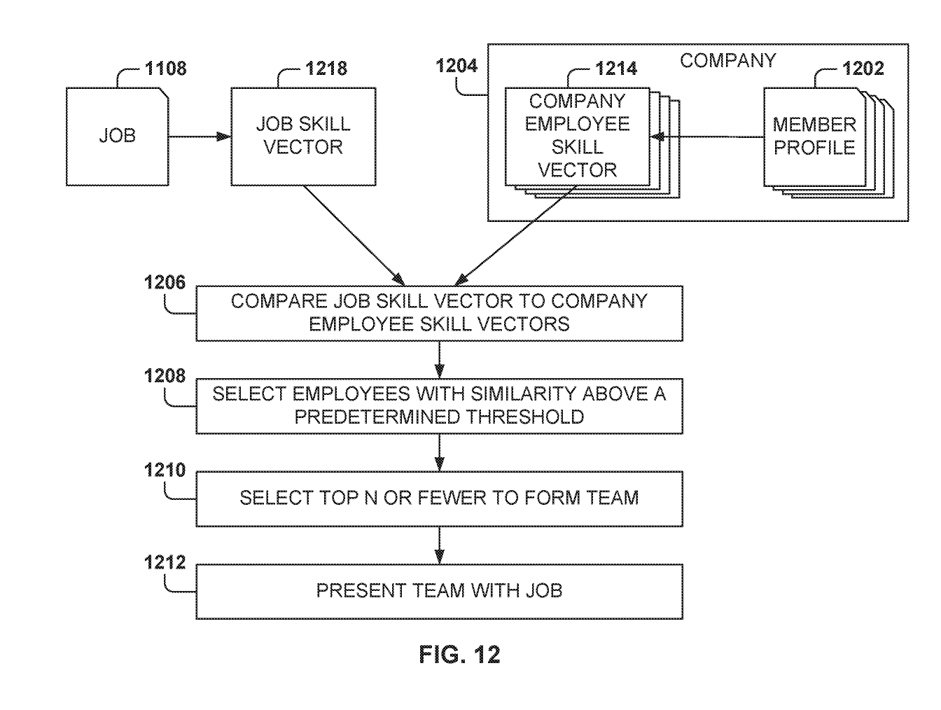

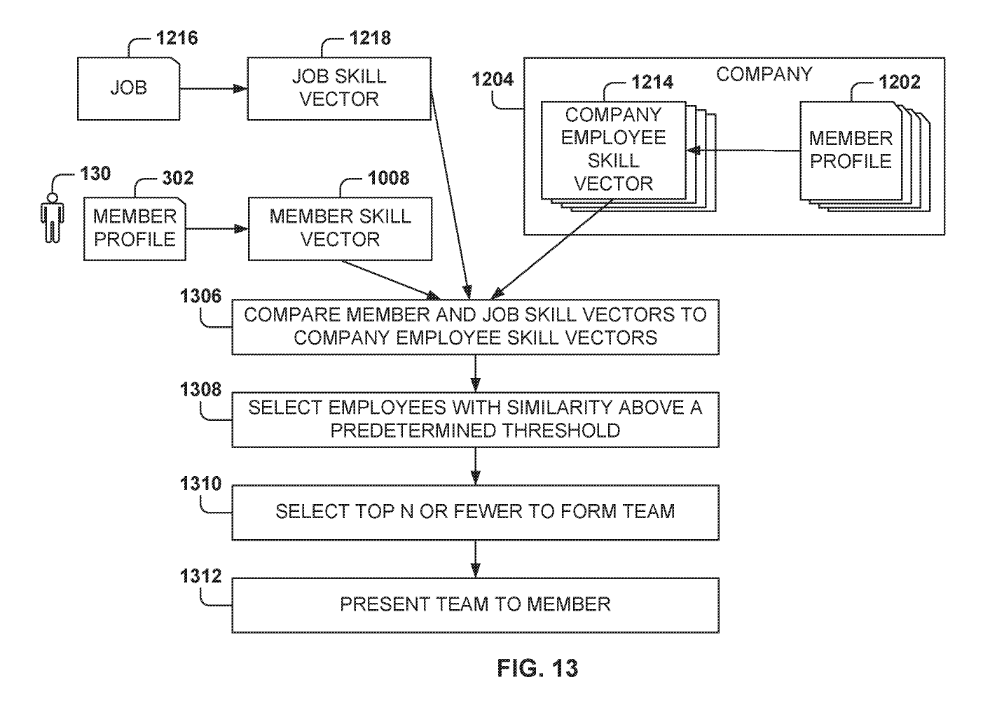

At operation 1118, the virtual team is found by selecting virtual team members who match the title 1110 (or optionally including the similar titles 1114) and the skills 1112 (or optionally including the similar skills 1116). More details on how to find the virtual team are provided below with reference to FIGS. 12 and 13.

At operation 1120, some of the jobs 1106 from the search are presented on a user interface, and the virtual teams are presented for one or more of these jobs, if virtual teams have been found for the jobs.

As discussed above, the virtual team is found based on job data, but in other embodiments the virtual team may be found based on the job data and the member data in order to further personalize the virtual team to the skills of the member. More details are provided below with reference to FIG. 13 regarding how to find virtual teams based on job data and member data.

FIG. 12 illustrates a method for presenting a virtual team, according to some example embodiments. In some example embodiments, job compressed skill vectors 1218 for a job 1108 are calculated based on the skills identified in (or extracted from) the job 1108.

Company employee compressed skill vectors 1214 for the employees of a company 1204 are calculated based on the employees' respective member profiles 1202. It is to be noted that the member profile 1202 may include demographic and professional information about the member, but may also include the activities performed by the member on the social network or in other networks (e.g., news websites).

In some example embodiments, geographic location is also used to filter the potential virtual team members, such that the virtual team member may be defined for a specific geographic location, which will match the geographic location for the job. Geographic location may be considered if similar teams are found in different locations, such as one team in Europe and another team in the United States. The member may be interested in finding out about the virtual team at the location where the job is offered.

At operation 1206, the job compressed skill vector 1218 is compared to the company employee compressed skill vectors 1214. For example, in one embodiment, the compressed skill vectors 1218 and 1214 are compared utilizing cosine similarity. In other embodiments, other similarity algorithms may be used to calculate the similarity coefficient.

At operation 1208, the employees with a similarity coefficient above a predetermined threshold are selected as candidates for the virtual team. In some example embodiments, the virtual team members are ranked according to the similarity coefficient.

From operation 1208, the method flows to operation 1210, where the top n (or fewer than n if there are less than n available) virtual team members are selected based on their similarity coefficients. The value of n may be in the range from two to fifty, although other values are also possible. In one example embodiment, if the member is looking at a job in his or her own company, the member may be eliminated from the virtual team since the similarity coefficient would be a perfect 100%. For example, this may be useful in case the member is looking for a different job within the same company.

The virtual team, based on the job posting, shows the member who the virtual team members are who are most similar to the job 1108 in the company 1204. Additionally, it shows the member who may compose the virtual team of the member if the member were to take the job 1108.

At operation 1212, the virtual team is presented to the member, such as at the user interfaces described above with reference to FIGS. 4 to 7. In other example embodiments, other job-related information may be used besides the job skills. For example, other embodiments may utilize the job title or the job function, or both, to obtain semantic compressed skill vectors that reflect the job skills, the job title, and the job function.

FIG. 13 illustrates a method for presenting a virtual team based on job skills and member skills, according to some example embodiments. The method of FIG. 13 is similar to the method of FIG. 12, but member information is also included to find the virtual team.

As discussed above, the job compressed skill vector 1218 and the company employee compressed skill vectors 1214 are calculated. In addition, a member compressed skill vector 1008 is obtained based on the member profile 302.

At operation 1306, the member and job compressed skill vectors 1008 and 1218 are compared to the company employee compressed skill vectors 1214 to determine a virtual team that matches the job skills.

In some example embodiments, the list of team members who match the job skills is calculated, as described above with reference to FIG. 12. If a member M is considering a job J from a company C, an ordered list P(J, C) of employees is calculated based on the K₁ nearest neighbors to job J in company C, where K₁ is a predetermined threshold (e.g., 10, but other values are also possible).

Afterwards, an ordered list Q(M, C) of the top K₂ nearest neighbors to member M of employees in company C is determined, by representing member M as a compressed skill vector, where K₂ is a predetermined threshold value (e.g., 20, but other values are also possible).

Once P(J, C) and Q(M, C) are calculated, aggregation of the two lists is performed to determine the top K “personalized nearest neighbors,” taking into account the rankings for both J and M. There are several ways to perform the aggregation of the two lists to finalize the list of virtual team members.

In some example embodiments, the lists are aggregated by treating P(J, C) as a candidate set and then ranking the list P(J, C) based on the ordering in Q(M, C). For example, scores may be provided based on the position of a candidate employee in each of the lists and then the scores may be combined to obtain the final virtual team list.

In other example embodiment, rank aggregation techniques may be used on both ordered lists, such as by using Borda ranking.

In other example embodiments, the lists are aggregated by combining similarity values of each employee E to both M and J. For example, the similarity values may be obtained by obtaining the cosine similarity between the compressed skill vectors of E and M or J. The combined similarity for E is then calculated according to the following formula:

CM(M,J,E)=H(MS(M,E),JS(J,E))

Here, CM is the combined similarity, MS is the member similarity, JS is the job similarity, and H is a function to combine the two similarities MS and JS. In one embodiment, H is a monotonically increasing function, such as a convex combination (e.g., H(MS,JS)=r·MS+(1−r)JS, or H(MS,JS)=MS^{r}·JS^{(1-r)}), where r is a tunable parameter to provide higher priority to MS or to JS. Other embodiments may utilize other mathematical functions to combine the two similarities.

At operation 1308, employees with a CM above a predetermined threshold are selected, and in operation 1310 the top n employees are selected to form the virtual team according to their CM similarity values. At operation 1312, the virtual team is presented to the member.

In other example embodiments, other job-related information may be used besides the job skills. For example, other embodiments may utilize the job title or the job function, or both, to obtain semantic compressed skill vectors that reflect the job skills, the job title, and the job function.

FIGS. 14A-14B illustrate the scoring of a job for a member, according to some example embodiments. FIG. 14A illustrates the scoring, also referred to herein as ranking, of a job 202 for a member associated with a member profile 302 based on a job affinity score 1406.

The job affinity score 1406, between a job and a member, is a value that measures how well the job matches the interest of the member in finding the job. A so-called “dream job” for a member would be the perfect job for the member and would have a high, or even maximum, value, while a job that the member is not interested in at all (e.g., in a different professional industry) would have a low job affinity score 1406. In some example embodiments, the job affinity score 1406 is a value between zero and one, or a value between zero and 100, although other ranges are possible.

In some example embodiments, a machine-learning program is used to calculate the job affinity scores for the jobs available to the member. The machine-learning program is trained with existing data in the social network, and the machine-learning program is then used to evaluate jobs based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, legal structure of the company (profit vs. nonprofit), and pay scale.

FIG. 14B illustrates the scoring of a job 202 for a member associated with the member profile 302, according to some example embodiments, based on three parameters: the job affinity score 1406, a job-to-group score 1408, and a group affinity score 1410. Broadly speaking, the job affinity score 1406 indicates how relevant the job 202 is to the member, the job-to-group score 1408 indicates how relevant the job 202 is to a group 1412, and the group affinity score 1410 indicates how relevant the group 1412 is to the member.

The group affinity score 1410 indicates how relevant the group 1412 is to the member, where a high affinity score indicates that the group 1412 is very relevant to the member and should be presented in the user interface, while a low affinity score indicates that the group 1412 is not relevant to the member and may be omitted from presentation in the user interface.

The group affinity score 1410 is used, in some example embodiments, to determine which groups 1412 are presented in the user interface, and the group affinity score 1410 is also used to order the groups 1412 when presenting them in the user interface, such that the groups 1412 may be presented in the order of their respective group affinity scores 1410. It is to be noted that if there is not enough “liquidity” of jobs for a group 1412 (e.g., there are not enough jobs for presentation in the group 1412), the group 1412 may be omitted from the user interface or presented with lower priority, even if the group affinity score 1410 is high.

In some example embodiments, a machine-learning program is utilized for calculating the group affinity score 1410. The machine-learning program is trained with member data, including interactions of users with the different groups 1412. The data for the particular member is then utilized by the machine-learning program to determine the group affinity score 1410 for the member with respect to a particular group 1412. The features utilized by the machine-learning program include the history of interaction of the member with jobs from the group 1412, click data for the member (e.g., a click rate based on how many times the member has interacted with the group 1412), member interactions with other members who have a relationship to the group 1412, etc. For example, one feature may include an attribute that indicates whether the member is a student; if the member is a student, features such as social connections or education-related attributes will be relevant to which groups are of interest to the student, while a member who has been out of school for 20 years or more may not be as interested in education-related features.

Another feature of interest to determine group participation is whether the member has worked in small companies or large companies throughout a long career. If the member exhibits a pattern of working for large companies, a group that provides jobs for large companies would likely be of more interest to the member than a group that provides jobs in small companies, unless there are other factors, such as recent interaction of the member with jobs from small companies.

The job-to-group score 1408 between a job 202 and a group 1412 indicates the job 202's strength within the context of the group 1412, where a high job-to-group score 1408 indicates that the job 202 is a good candidate for presentation within the group 1412 and a low job-to-group score 1408 indicates that the job 202 is not a good candidate for presentation within the group 1412. In some example embodiments, a predetermined threshold is identified, wherein jobs 202 with a job-to-group score 1408 equal to or above the predetermined threshold are included in the group 1412 and jobs 202 with a job-to-group score 1408 below the predetermined threshold are not included in the group 1412.

For example, in a group 1412 that presents jobs within the social network of the member, if there is a job 202 for a company within the network of the member, the job-to-group score 1408 indicates how strong the member's network is for reaching the company of the job 202.

In some example embodiments, the job affinity score 1406, the job-to-group score 1408, and the group affinity score 1410 are combined to obtain a combined score 1414 for the job 202. The scores may be combined utilizing addition, weighted averaging, or other mathematical operations.

FIG. 14B illustrates that, for a given job 202 and member profile 302, there may be a plurality of groups 1412 G1, . . . , GN. Embodiments presented herein identify which jobs fit better in which group, and which groups have higher priority for presentation to the member.

In the virtual-team group, the job-to-group score 1408 measures the strength of the virtual team for the company associated with the job. In the virtual-team ranking phase, a score is assigned to each virtual team member based on their professional accomplishments, such as education, companies worked at, years of experience, number of followers, number of presentations at major conferences, number of published papers, number of issued patents, number of skill endorsements, etc. Thus, the professional strength for each member of the virtual team is calculated and then an aggregated value is calculated for the virtual team.

As discussed above, geographic location may also be entered into the search, such that the member may ask, “What is the best machine-learning team in Silicon Valley?”

In other embodiments, additional criteria may be included in the ranking of the virtual teams. For example, if the member wants to work for small teams, the team size may be used to rank the virtual teams.

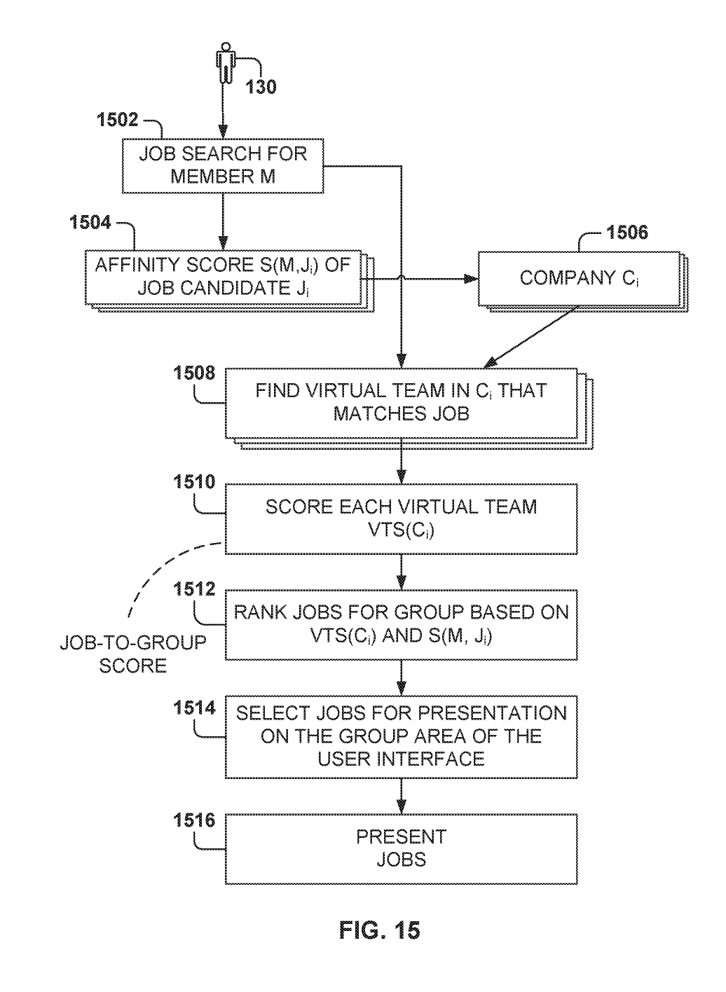

FIG. 15 illustrates a method for selecting jobs for presentation within the group, according to some example embodiments. At operation 1502, a job search is performed for a member M 130. The job search may be originated by the member, or may be originated by the social network in order to propose job postings to the member. The result 1504 is a plurality of candidate jobs Jᵢ for presentation to the member based on their affinity scores S(M, Jᵢ). In some embodiments, the candidate jobs Jᵢ may be filtered. In one example embodiment, the candidate jobs having affinity scores S(M, Jᵢ) higher than or equal to a predetermined threshold are considered for presentation, while candidate jobs having affinity scores S(M, Jᵢ) lower than the predetermined threshold are omitted from consideration for presentation to the member.

Each candidate job Jᵢ is associated with a respective company Cᵢ 1506, and in operation 1508 the virtual team is found, if there are members available to form the virtual team, for each company Cᵢ 1506, where the virtual team members have similar skills to the job skills of the candidate job Jᵢ, as discussed above with reference to FIGS. 12-13.

The job-to-group score 1408 for the virtual team group is called the virtual-team score VTS. The virtual-team score VTS(Cᵢ) for company Cᵢ is calculated in operation 1510 based on a professional score PS for each of the virtual team members, also referred to as a skill metric. The virtual-team score VTS(Cᵢ) is calculated for each job Jᵢ by combining the PSⱼ for all the virtual-team members Mⱼ at company Cᵢ. The combination may be performed by multiplying the scores, by adding the scores, using the maximum of the scores, by performing a weighted multiplication, by performing a weighted addition, or by calculating the geometric mean, the average, etc.

In some embodiments, the members with a high PS are given higher weights than other members because the members with the high PS are usually leaders who greatly increase the value of the virtual team (e.g., a software developer with 20 years of experience and who is a Chief Technical Officer). Thus, in some example embodiments, the VTS is calculated as a weighted average of the professional scores PSⱼ of the virtual team members, wherein virtual team members with higher professional scores have higher weights than virtual team members with lower professional scores.

The PS is calculated based on the professional accomplishments of the member, which may include consideration of any of a plurality of factors that include number of years of experience, number of published papers, number of patents obtained, number of companies founded, number of followers in a social network, articles published about the member, and a score for the company where the virtual team member works. For example, if the virtual team includes team members who have started companies, the team will be considered highly entrepreneurial and will be given a high score when the member is searching for startup jobs.

In other example embodiments, the virtual-team score may also be based on the evolution of the company over time. For example, if the company has experienced high growth in the last two years, the score for the virtual team will be increased. Another factor that may be used for scoring the virtual team is a calculation of the value of the company (e.g., measured by the value of the issued stock divided by the number of employees).

In some example embodiments, a limited number of members are selected for calculating the virtual team score in operation 1510. For example, the top ten virtual team members are selected according to their professional scores for calculating the virtual team score. If the team has fewer than ten members, then the virtual team score is adjusted accordingly based on the number of available members. In other embodiments, a different number of members may be selected, such as in the range from three to 20, or some other value.

At operation 1512, the candidate jobs are ranked according to their VTS and S scores, where the best jobs for the member M will be at the top of the ranked list of candidate jobs. In some example embodiments, a machine-learning program is used to rank the jobs based on their VTS and S scores. The machine-learning program is trained with activity data of members of the social network, and then the member activity and the different job-related scores are used to rank the jobs for the member.

At operation 1514, a predetermined number of the top candidate jobs are selected for presentation in the group area (e.g., group area 408) of the user interface. For example, six jobs may be presented per group (as long as there are six jobs available for each group), or a different number of jobs may be presented per group, such as a number in the range from one to ten. Further, in some example embodiments, groups with higher ranks may present more jobs than groups with lower ranks. For example, a top group may present ten jobs, and each of the remaining groups may present four jobs.

At operation 1516, the selected jobs are presented in the user interface. It is to be noted that the different groups are ranked according to their scores and then placed in the order of their ranking in the user interface.

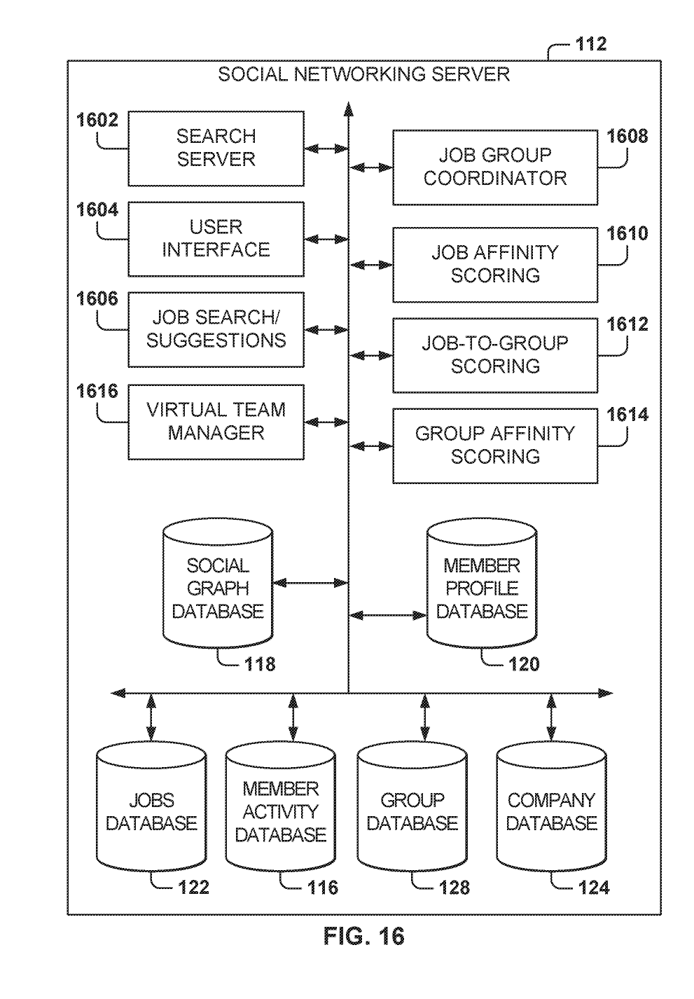

FIG. 16 illustrates a social networking server 112 for implementing example embodiments. In one example embodiment, the social networking server 112 includes a search server 1602, a user interface module 1604, a job search/suggestions engine 1606, a virtual team manager 1616, a job group coordinator server 1608, a job affinity scoring server 1610, a job-to-group scoring server 1612, a group affinity scoring server 1614, and a plurality of databases, which include the social graph database 118, the member profile database 120, the jobs database 122, the member activity database 116, the group database 128, and the company database 124.

The search server 1602 performs data searches on the social network, such as searches for members or companies. In some example embodiments, the search server 1602 includes a machine-learning algorithm for performing the searches that utilizes a plurality of features for selecting and scoring the jobs. The features include, at least, one or more of: title, industry, skills, member profile, company profile, job title, job data, region, and salary range. The user interface module 1604 communicates with the client devices 104 to exchange user interface data for presenting the user interface to the user. The job search/suggestions engine 1606 performs job searches based on a search query (e.g., using one or more keywords and a geographic location as illustrated in FIG. 4) or based on a member profile in order to offer job suggestions.

The virtual team manager 1616 determines the composition of the virtual teams, e.g., the members who belong in each virtual team for the different companies. The job affinity scoring server 1610 calculates the job affinity scores, as illustrated above with reference to FIGS. 14A-14B. The job-to-group scoring server 1612 calculates the job-to-group scores, as illustrated above with reference to FIGS. 14B and 15. The group affinity scoring server 1614 calculates the group affinity scores, as illustrated above with reference to FIGS. 14B and 15.

The job group coordinator server 1608 calculates the combined score for the scores identified above. The job group coordinator server 1608 further ranks the different groups in order to determine the priority of presentation of the groups in the user interface, and which groups will be presented or omitted. In addition, the job group coordinator server 1608 may determine in which group to present a job, if the job could be presented in two or more groups.

It is to be noted that the embodiments illustrated in FIG. 16 are examples and do not describe every possible embodiment. Other embodiments may utilize different servers or additional servers, combine the functionality of two or more servers into a single server, utilize a distributed server pool, and so forth. The embodiments illustrated in FIG. 16 should therefore not be interpreted to be exclusive or limiting, but rather illustrative.

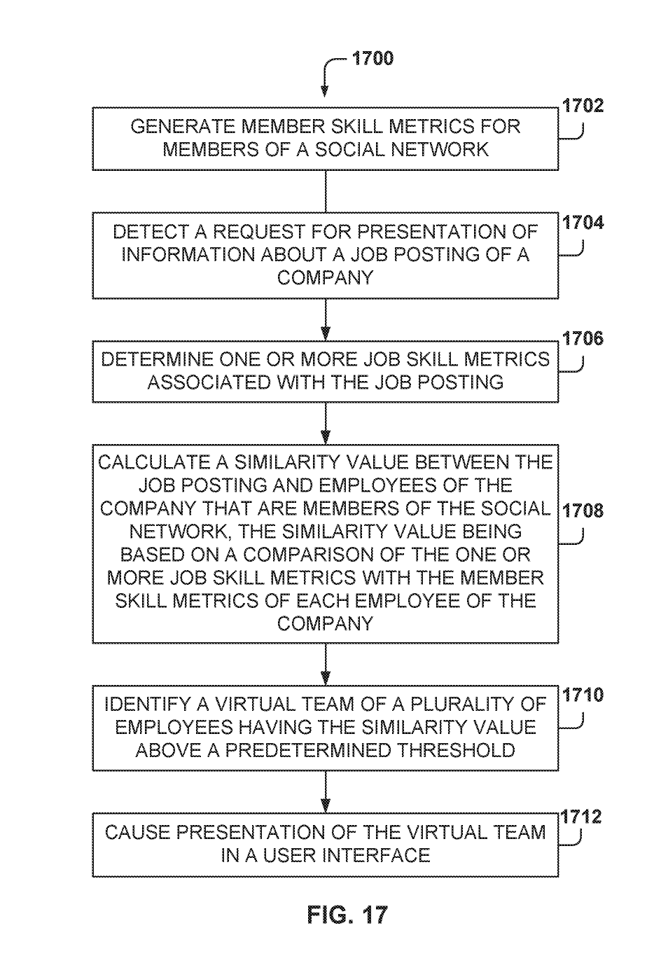

FIG. 17 is a flowchart of a method 1700, according to some example embodiments, for finding a virtual team in a company based on the skills identified in a job posting, such that the virtual team members have similar skills to the skills in the job posting. Operation 1702 is for generating, by one or more processors, member skill metrics for members of a social network.

From operation 1702, the method flows to operation 1704 for detecting a request for presentation of information about a job posting of a company. Operation 1706 is for determining one or more job skill metrics associated with the job posting.

From operation 1706, the method flows to operation 1708 where the one or more processors calculate a similarity value between the job posting and each of one or more employees of the company who are members of the social network. The similarity values are based on a comparison of the one or more job skill metrics with the member skill metrics of each employee of the company.

At operation 1710, the one or more processors identify a virtual team of a plurality of employees having the similarity value above a predetermined threshold, and at operation 1712, the virtual team is presented in a user interface.

In one example, the member skill metrics include a vector formed by aggregating a skill vector for each skill of the member, the skill vector including values calculated by a machine-learning program, where similar skills have similar skill vectors.

In another example, the one or more job skill metrics include a vector formed by aggregating a job skill vector for each desired job skill identified in the job posting.

In one example, the similarity value is calculated as a cosine similarity between the member skill vector and the job skill vector.

In some embodiments, the member skill metrics include a vector formed by aggregating a title vector of the member and a skill vector for each skill of the member, the title vector and the skill vector having respective values calculated by a machine-learning program, where similar skills have similar skill vectors and similar titles have similar title vectors.

In other examples, the job skill metrics include a vector formed by aggregating a title vector of the job posting and a job skill vector for each desired job skill identified in the job posting, the title vector and the job skill vector having respective values calculated by a machine-learning program.

In one example, the similarity value is calculated by a machine-learning program trained with skill data for the members of the social network, the machine-learning program calculating the similarity value that is correlated to a similarity of skills in the job posting and skills of the member.

In some examples, each member is associated with a member profile containing a plurality of skills and endorsements for each skill.

In some examples, the method 1700 further includes presenting in the user interface information about a commonality of skills between the member viewing the job posting and members in the virtual team.

In some examples, three to six members in the virtual team are presented in the user interface.

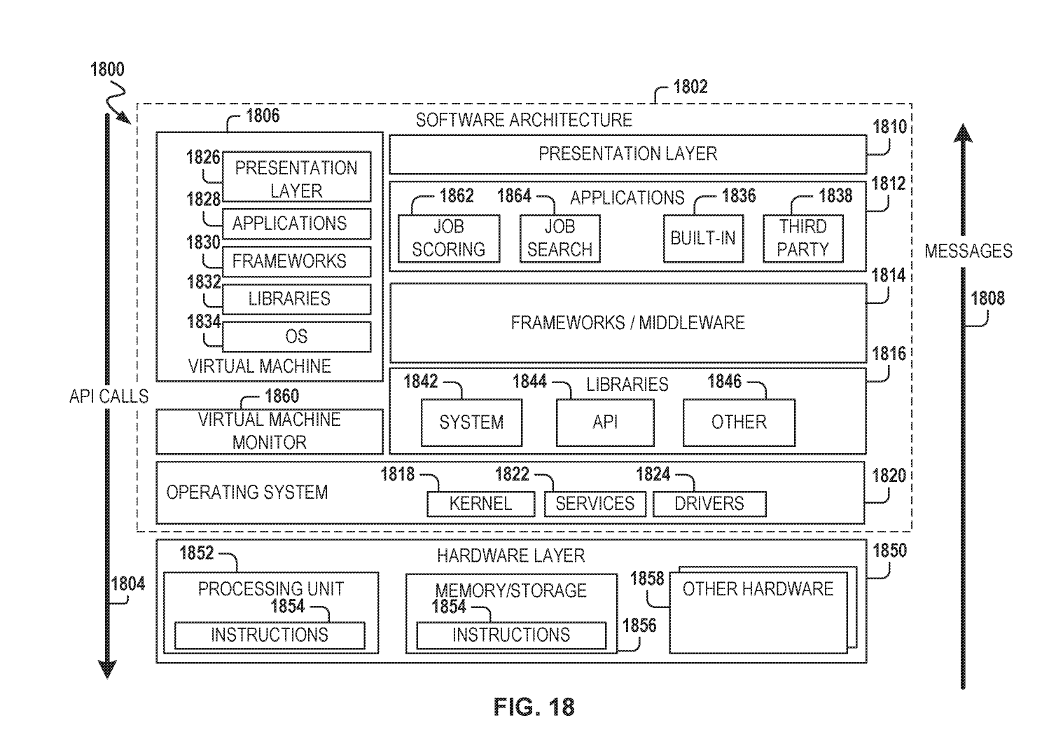

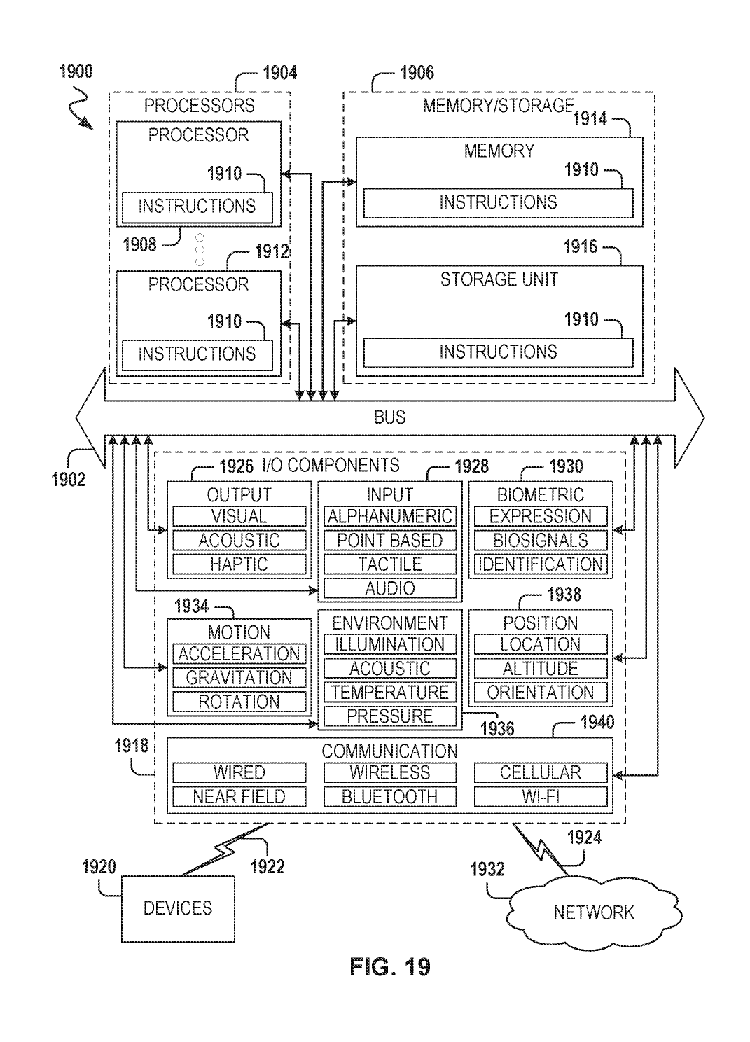

FIG. 18 is a block diagram 1800 illustrating a representative software architecture 1802, which may be used in conjunction with various hardware architectures herein described. FIG. 18 is merely a non-limiting example of a software architecture 1802, and it will be appreciated that many other architectures may be implemented to facilitate the functionality described herein. The software architecture 1802 may be executing on hardware such as a machine 1900 of FIG. 19 that includes, among other things, processors 1904, memory/storage 1906, and input/output (I/O) components 1918. A representative hardware layer 1850 is illustrated and can represent, for example, the machine 1900 of FIG. 19. The representative hardware layer 1850 comprises one or more processing units 1852 having associated executable instructions 1854. The executable instructions 1854 represent the executable instructions of the software architecture 1802, including implementation of the methods, modules, and so forth of FIGS. 1-6, 8, 10-13, 15, and 17. The hardware layer 1850 also includes memory and/or storage modules 1856, which also have the executable instructions 1854. The hardware layer 1850 may also comprise other hardware 1858, which represents any other hardware of the hardware layer 1850, such as the other hardware illustrated as part of the machine 1900.

In the example architecture of FIG. 18, the software architecture 1802 may be conceptualized as a stack of layers where each layer provides particular functionality. For example, the software architecture 1802 may include layers such as an operating system 1820, libraries 1816, frameworks/middleware 1814, applications 1812, and a presentation layer 1810. Operationally, the applications 1812 and/or other components within the layers may invoke application programming interface (API) calls 1804 through the software stack and receive a response, returned values, and so forth illustrated as messages 1808 in response to the API calls 1804. The layers illustrated are representative in nature, and not all software architectures have all layers. For example, some mobile or special-purpose operating systems may not provide a frameworks/middleware 1814 layer, while others may provide such a layer. Other software architectures may include additional or different layers.

The operating system 1820 may manage hardware resources and provide common services. The operating system 1820 may include, for example, a kernel 1818, services 1822, and drivers 1824. The kernel 1818 may act as an abstraction layer between the hardware and the other software layers. For example, the kernel 1818 may be responsible for memory management, processor management (e.g., scheduling), component management, networking, security settings, and so on. The services 1822 may provide other common services for the other software layers. The drivers 1824 may be responsible for controlling or interfacing with the underlying hardware. For instance, the drivers 1824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1816 may provide a common infrastructure that may be utilized by the applications 1812 and/or other components and/or layers. The libraries 1816 typically provide functionality that allows other software modules to perform tasks in an easier fashion than by interfacing directly with the underlying operating system 1820 functionality (e.g., kernel 1818, services 1822, and/or drivers 1824). The libraries 1816 may include system libraries 1842 (e.g., C standard library) that may provide functions such as memory allocation functions, string manipulation functions, mathematic functions, and the like. In addition, the libraries 1816 may include API libraries 1844 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1816 may also include a wide variety of other libraries 1846 to provide many other APIs to the applications 1812 and other software components/modules.

The frameworks 1814 (also sometimes referred to as middleware) may provide a higher-level common infrastructure that may be utilized by the applications 1812 and/or other software components/modules. For example, the frameworks 1814 may provide various graphic user interface (GUI) functions, high-level resource management, high-level location services, and so forth. The frameworks 1814 may provide a broad spectrum of other APIs that may be utilized by the applications 1812 and/or other software components/modules, some of which may be specific to a particular operating system or platform.

The applications 1812 include job-scoring applications 1862, job search/suggestion applications 1864, built-in applications 1836, and third-party applications 1838. The job-scoring applications 1862 comprise the job-scoring applications as discussed above with reference to FIG. 16. Examples of representative built-in applications 1836 may include, but are not limited to, a contacts application, a browser application, a book reader application, a location application, a media application, a messaging application, and/or a game application. The third-party applications 1838 may include any of the built-in applications 1836 as well as a broad assortment of other applications. In a specific example, the third-party applications 1838 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party applications 1838 may invoke the API calls 1804 provided by the mobile operating system such as the operating system 1820 to facilitate functionality described herein.

The applications 1812 may utilize built-in operating system functions (e.g., kernel 1818, services 1822, and/or drivers 1824), libraries (e.g., system libraries 1842, API libraries 1844, and other libraries 1846), or frameworks/middleware 1814 to create user interfaces to interact with users of the system. Alternatively, or additionally, in some systems, interactions with a user may occur through a presentation layer, such as the presentation layer 1810. In these systems, the application/module “logic” can be separated from the aspects of the application/module that interact with a user.

Some software architectures utilize virtual machines. In the example of FIG. 18, this is illustrated by a virtual machine 1806. A virtual machine creates a software environment where applications/modules can execute as if they were executing on a hardware machine (such as the machine 1900 of FIG. 19, for example). The virtual machine 1806 is hosted by a host operating system (e.g., operating system 1820 in FIG. 18) and typically, although not always, has a virtual machine monitor 1860, which manages the operation of the virtual machine 1806 as well as the interface with the host operating system (e.g., operating system 1820). A software architecture executes within the virtual machine 1806, such as an operating system 1834, libraries 1832, frameworks/middleware 1830, applications 1828, and/or a presentation layer 1826. These layers of software architecture executing within the virtual machine 1806 can be the same as corresponding layers previously described or may be different.

FIG. 19 is a block diagram illustrating components of a machine 1900, according to sonic example embodiments, able to read instructions from a machine-readable medium (e.g., a machine-readable storage medium) and perform any one or more of the methodologies discussed herein. Specifically, FIG. 19 shows a diagrammatic representation of the machine 1900 in the example form of a computer system, within which instructions 1910 (e.g., software, a program, an application, an applet, an app, or other executable code) for causing the machine 1900 to perform any one or more of the methodologies discussed herein may be executed. For example, the instructions 1910 may cause the machine 1900 to execute the flow diagrams of FIGS. 9-13, 15, and 17. Additionally, or alternatively, the instructions 1910 may implement the job-scoring programs and the machine-learning programs associated with them. The instructions 1910 transform the general, non-programmed machine 1900 into a particular machine 1900 programmed to carry out the described and illustrated functions in the manner described.

In alternative embodiments, the machine 1900 operates as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1910, sequentially or otherwise, that specify actions to be taken by the machine 1900. Further, while only a single machine 1900 is illustrated, the term “machine” shall also be taken to include a collection of machines 1900 that individually or jointly execute the instructions 1910 to perform any one or more of the methodologies discussed herein.

The machine 1900 may include processors 1904, memory/storage 1906, and I/O components 1918, which may be configured to communicate with each other such as via a bus 1902. In an example embodiment, the processors 1904 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1908 and a processor 1912 that may execute the instructions 1910. The term “processor” is intended to include multi-core processors that may comprise two or more independent processors (sometimes referred to as “cores”) that may execute instructions contemporaneously. Although FIG. 19 shows multiple processors 1904, the machine 1900 may include a single processor with a single core, a single processor with multiple cores (e.g., a multi-core processor), multiple processors with a single core, multiple processors with multiples cores, or any combination thereof.

The memory/storage 1906 may include a memory 1914, such as a main memory, or other memory storage, and a storage unit 1916, both accessible to the processors 1904 such as via the bus 1902. The storage unit 1916 and memory 1914 store the instructions 1910 embodying any one or more of the methodologies or functions described herein. The instructions 1910 may also reside, completely or partially, within the memory 1914, within the storage unit 1916, within at least one of the processors 1904 (e.g., within the processor's cache memory), or any suitable combination thereof, during execution thereof by the machine 1900. Accordingly, the memory 1914, the storage unit 1916, and the memory of the processors 1904 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1910. The term “machine-readable medium” shall also be taken to include any medium, or combination of multiple media, that is capable of storing instructions (e.g., instructions 1910) for execution by a machine (e.g., machine 1900), such that the instructions, when executed by one or more processors of the machine (e.g., processors 1904), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1918 may include a wide variety of components to receive input, provide output, produce output, transmit information, exchange information, capture measurements, and so on. The specific I/O components 1918 that are included in a particular machine will depend on the type of machine. For example, portable machines such as mobile phones will likely include a touch input device or other such input mechanisms, while a headless server machine will likely not include such a touch input device. It will be appreciated that the I/O components 1918 may include many other components that are not shown in FIG. 19. The I/O components 1918 are grouped according to functionality merely for simplifying the following discussion, and the grouping is in no way limiting. In various example embodiments, the I/O components 1918 may include output components 1926 and input components 1928. The output components 1926 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1918 may include biometric components 1930, motion components 1934, environmental components 1936, or position components 1938 among a wide array of other components. For example, the biometric components 1930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1934 may include acceleration sensor components (e.g., accelerometer), gravitation sensor components, rotation sensor components (e.g., gyroscope), and so forth. The environmental components 1936 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1938 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1918 may include communication components 1940 operable to couple the machine 1900 to a network 1932 or devices 1920 via a coupling 1924 and a coupling 1922, respectively. For example, the communication components 1940 may include a network interface component or other suitable device to interface with the network 1932. In further examples, the communication components 1940 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 1920 may be another machine or any of a wide variety of peripheral devices (e.g., a peripheral device coupled via a USB).

Moreover, the communication components 1940 may detect identifiers or include components operable to detect identifiers. For example, the communication components 1940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1940, such as location via Internet Protocol (IP) geo-location, location via Wi-Fi® signal triangulation, location via detecting an NEC beacon signal that may indicate a particular location, and so forth.

In various example embodiments, one or more portions of the network 1932 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1932 or a portion of the network 1932 may include a wireless or cellular network and the coupling 1924 may be a Code Division Multiple Access (CDMA) connection, a Global System for Mobile communications (GSM) connection, or another type of cellular or wireless coupling. In this example, the coupling 1924 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1910 may be transmitted or received over the network 1932 using a transmission medium via a network interface device (e.g., a network interface component included in the communication components 1940) and utilizing any one of a number of well-known transfer protocols (e.g., hypertext transfer protocol (HTTP)). Similarly, the instructions 1910 may be transmitted or received using a transmission medium via the coupling 1922 (e.g., a peer-to-peer coupling) to the devices 1920. The term “transmission medium” shall be taken to include any intangible medium that is capable of storing, encoding, or carrying the instructions 1910 for execution by the machine 1900, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
generating, by one or more processors, member skill metrics for members of a social network;
detecting a request for presentation of information about a job posting of a company;
determining one or more job skill metrics associated with the job posting;
calculating, by the one or more processors, a similarity value between the job posting and each of one or more employees of the company who are members of the social network, the similarity value being based on a comparison of the one or more job skill metrics with the member skill metrics of each employee of the company;
identifying, by the one or more processors, a virtual team of a plurality of employees having similarity values above a predetermined threshold; and
causing presentation of the virtual team in a user interface.

2. The method as recited in claim 1, wherein the member skill metrics comprise a vector formed by aggregating a skill vector for each skill of the member, the skill vector including values calculated by a machine-learning program, wherein similar skills have similar skill vectors.

3. The method as recited in claim 2, wherein the one or more job skill metrics comprise a vector formed by aggregating a job skill vector for each desired job skill identified in the job posting.

4. The method as recited in claim 3, wherein each similarity value is calculated as a cosine similarity between the member skill vector and the job skill vector.

5. The method as recited in claim 1, wherein the member skill metrics comprise a vector formed by aggregating a title vector of the member and a skill vector for each skill of the member, the title vector and the skill vectors having respective values calculated by a machine-learning program, wherein similar skills have similar skill vectors and similar titles have similar title vectors.

6. The method as recited in claim 5, wherein the one or more job skill metrics comprise a vector formed by aggregating a title vector of the job posting and a job skill vector for each desired job skill identified in the job posting, the title vector and the job skill vectors having respective values calculated by the machine-learning program.

7. The method as recited in claim 1, wherein each similarity value is calculated by a machine-learning program trained with skill data for the members of the social network, the machine-learning program calculating the similarity value that is correlated to a similarity of skills in the job posting and skills of the member.

8. The method as recited in claim 1, wherein each member is associated with a member profile containing a plurality of skills and endorsements for each skill.

9. The method as recited in claim 1, further comprising:
presenting in the user interface information about a commonality of skills between a member viewing the job posting and members in the virtual team.

10. The method as recited in claim 1, wherein three to six members in the virtual team are presented in the user interface.

11. A system comprising:
a memory comprising instructions; and
one or more computer processors, wherein the instructions, when executed by the one or more computer processors, cause the one or more computer processors to perform operations comprising:
generating member skill metrics for members of a social network;
detecting a request for presentation of information about a job posting of a company;
determining one or more job skill metrics associated with the job posting;
calculating a similarity value between the job posting and each of one or more employees of the company who are members of the social network, the similarity value being based on a comparison of the one or more job skill metrics with the member skill metrics of each employee of the company;
identifying a virtual team of a plurality of employees having similarity values above a predetermined threshold; and
causing presentation of the virtual team in a user interface.

12. The system as recited in claim 11, wherein the member skill metrics comprise a vector formed by aggregating a skill vector for each skill of the member, the skill vector including values calculated by a machine-learning program, wherein similar skills have similar skill vectors, wherein the one or more job skill metrics comprise a vector formed by aggregating a job skill vector for each desired job skill identified in the job posting.

13. The system as recited in claim 12, wherein each similarity value is calculated as a cosine similarity between the member skill vector and the job skill vector.

14. The system as recited in claim 11, wherein the member skill metrics comprise a vector formed by aggregating a title vector of the member and a skill vector for each skill of the member, the title vector and the skill vectors having respective values calculated by a machine-learning program, wherein similar skills have similar skill vectors and similar titles have similar title vectors.

15. The system as recited in claim 14, wherein the one or more job skill metrics comprise a vector formed by aggregating a title vector of the job posting and a job skill vector for each desired job skill identified in the job posting, the title vector and the job skill vectors having respective values calculated by the machine-learning program.

16. A non-transitory machine-readable storage medium including instructions that, when executed by a machine, cause the machine to perform operations comprising:
generating member skill metrics for members of a social network;
detecting a request for presentation of information about a job posting of a company;
determining one or more job skill metrics associated with the job posting;
calculating a similarity value between the job posting and each of one or more employees of the company who are members of the social network, the similarity value being based on a comparison of the one or more job skill metrics with the member skill metrics of each employee of the company;
identifying a virtual team of a plurality of employees having similarity values above a predetermined threshold; and
causing presentation of the virtual team in a user interface.

17. The machine-readable storage medium as recited in claim 16, wherein the member skill metrics comprise a vector formed by aggregating a skill vector for each skill of the member, the skill vector including values calculated by a machine-learning program, wherein similar skills have similar skill vectors, wherein the one or more job skill metrics comprise a vector formed by aggregating a job skill vector for each desired job skill identified in the job posting.

18. The machine-readable storage medium as recited in claim 17, wherein each similarity value is calculated as a cosine similarity between the member skill vector and the job skill vector.

19. The machine-readable storage medium as recited in claim 16, wherein the member skill metrics comprise a vector formed by aggregating a title vector of the member and a skill vector for each skill of the member, the title vector and the skill vectors having respective values calculated by a machine-learning program, wherein similar skills have similar skill vectors and similar titles have similar title vectors.

20. The machine-readable storage medium as recited in claim 19, wherein the one or more job skill metrics comprise a vector formed by aggregating a title vector of the job posting and a job skill vector for each desired job skill identified in the job posting, the title vector and the job skill vectors having respective values calculated by the machine-learning program.
